(19) United States
(12) Patent Application Publication
(10) Pub. No.: US 2004/0204179 A1
(43) Pub. Date: Oct. 14, 2004

(54) Multi-socket solar energy converting battery charger for mobile phone

(76) Inventor: Mao-Sung Hsu, Ping-Tung Hsien (TW)

Correspondence Address: BIRCH STEWART KOLASCH & BIRCH, PO BOX 747, FALLS CHURCH, VA, 22040-0747, US

(21) Appl. No.: 10/241,768

(22) Filed: Sep. 12, 2002

(51) Int. Cl. H04B 1/38

(52) U.S. Cl. 455/573; 455/572; 455/575.1; 455/90.1; 455/550.1

(57) ABSTRACT

A multi-socket solar energy converting battery charger for mobile phone that is easily portable and capable of converting sunlight to electricity to charge the mobile phone. The battery charger comprises a case part and a over part that respectively mount solar panels. The battery charger further includes a circuit board that has a protection circuit, particular circuits, and a voltage stabilizing circuit to stabilize the charging voltage. The circuit board is further connected to a socket through which the battery charger connects a converter socket block to accommodate different types of mobile phones.

### FIELD OF THE INVENTION

The invention relates to a multi-socket solar energy converting battery charger for mobile phone and, more particularly, to a battery charger capable of charging a mobile phone from solar energy.

### BACKGROUND OF THE INVENTION

As illustrated in FIG. 1, a connector module for mobile phone currently known in the art allows the simultaneous connection of a car charger plug and an earphone cable plug. However, the use of this connector module may have the following inconveniences.

(1) This type of connector module, when connected to a car charger plug for charging the battery of the mobile phone, usually needs an additional charging circuit that converts the power source provided at the car cigarette igniter socket. However, the power source provided by the car igniter socket may be irregularly sufficient. When the car engine is stopped and restarted, the resulting current pulse may be excessive and damage the components of the mobile phone.

(2) This type of connector module is only adapted to car charger plug. Therefore, if the user is outdoor at a place without power source or with a power source but the user does not have with him/her a portable charger, the mobile phone cannot be charged.

(3) A conventional battery charger for mobile phone is usually voluminous and heavy, it is therefore not easily portable. Most of the time, the mobile phone is therefore charged via a battery charger connected with the power source of wall socket providing an alternating voltage of 110V. This high voltage, if not adequately converted by the battery charger, may damage the components of the mobile phone and shortens its service life.

(4) Because the conventional battery charger is not easily portable, the use of the above connector module of the prior art therefore is not well adapted for charging the mobile phone.

### SUMMARY OF THE INVENTION

Accordingly, it is a principal object of the invention to provide a battery charger for mobile phone that is capable of charging different types of mobile phones. The battery charger comprises a socket through which a connecting cable can connect the battery charger to a converter socket block that is capable of accommodating different types of mobile phone. The battery charger is further equipped with solar panels that convert sunlight to electricity for charging the mobile phone.

It is another object of the invention to provide a circuit board within the battery charger that includes a protection circuit, particular circuits, and a voltage stabilizing circuit that are capable of adequately handling the electricity converted by the solar panels to charge the mobile phone. Thereby, the battery charger is easily portable and is capable of charging the mobile phone at any places without electrical power sources.

Furthermore, it is another object of the invention to provide a circuit board within the battery charger that includes a converter circuit capable of adequately converting the power source from a car cigarette igniter socket. The provided charging voltage thereby is not excessively high, which prevents damages of the mobile phone.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view schematically illustrating a connector module for mobile phone of the prior art;

FIG. 2 is an exploded view schematically illustrating a battery charger for mobile phone according to an embodiment of the invention;

FIG. 3A is a perspective view schematically showing a battery charger according to an embodiment of the invention;

FIG. 3B is a perspective view schematically showing the battery charger of the invention in an unfolded configuration;

FIG. 4 is a schematic view illustrating the connection of the battery charger of the invention to a car charger plug or a portable charger plug, and a mobile phone; and

FIG. 5 is a perspective view schematically illustrating the connection of the battery charger of the invention to the converter socket block.

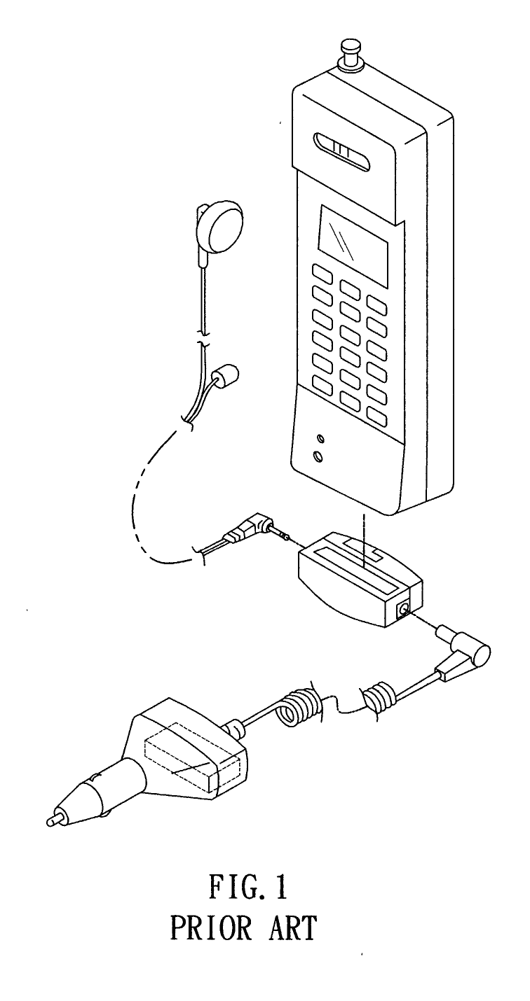

### DETAILED DESCRIPTION OF THE EMBODIMENTS

Wherever possible in the following description, like reference numerals will refer to like elements and parts unless otherwise illustrated.

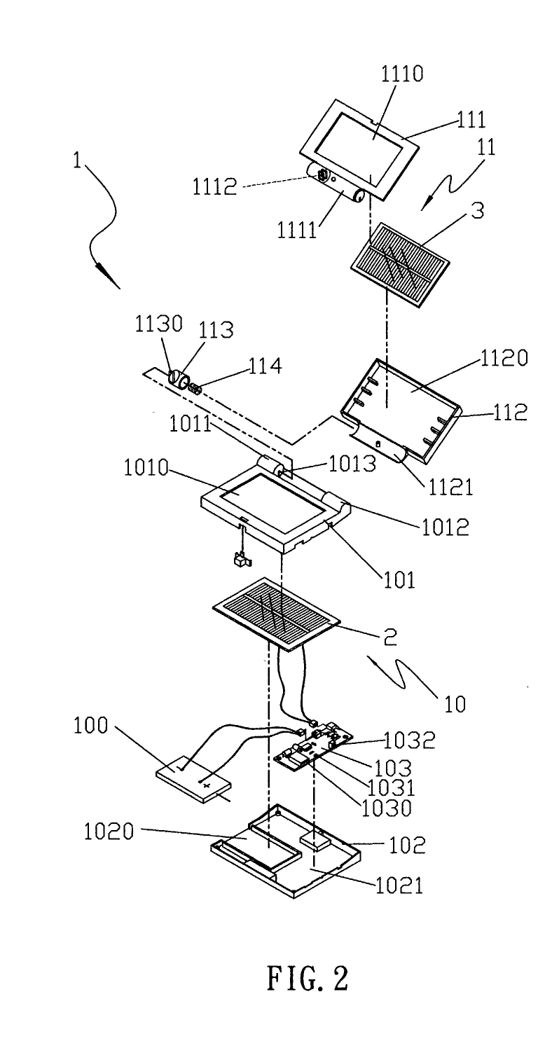

Referring to FIG. 2, an exploded view schematically illustrates a battery charger adapted to electrically charge different types of mobile phone according to an embodiment of the invention. As illustrated, a battery charger 1 of the invention comprises a case part 10 that pivotally connects a cover part 11 via attachment panels 101, 111. The attachment panels 101, 111 are provided with openings 1010, 1110 that expose solar panels 2, 3 respectively composed of photovoltaic cells that are capable of converting sunlight to electricity.

The case part 10 includes a tray 102 that defines two receiving spaces 1020, 1021 where are respectively received a battery 100 and a circuit board 103. The circuit board 103 electrically connects the solar panels 2, 3 and the battery 100. The solar panel 2 is matingly mounted into the opening 1010 of the attachment panel 101. At a side of the case part 10 is defined a socket area comprising a socket 1030 and a socket 1032, respectively placed in rectangular and square openings 12, 13, that electrically connect the circuit board 103. The socket 1030 matingly engages with a plug 41 of a connecting cable 4 and the socket 1032 matingly engages with a car battery charger plug 5 or a potable battery charger plug 6. The socket area further includes a groove 13 through which is exposed a light-emitting diode (LED) 1031 electrically connecting the circuit board 103. Furthermore, attachment projections 1011, 1012 respectively protrudes on left and right sides of the attachment panel 101, the attachment projection 1011 being inwardly provided with a long cavity 1013.

As shown in FIG. 2, the cover part 11 comprises the attachment panel 111 and a lower casing 112 in which is mounted the solar panel 3. The attachment panel 111 and the lower casing 112 respectively include corresponding partial cylinders 1111, 1121 that mate with each other and in which is placed a cylindrical rod 113. The cylindrical rod 113 includes a boss 1130 and a spring 114 that abuts against an abutment 1112 within the partial cylinder 1111. The cover part 11 is pivotally connected to the case part 10 via insertion of the boss 1130 in the cavity 1013.

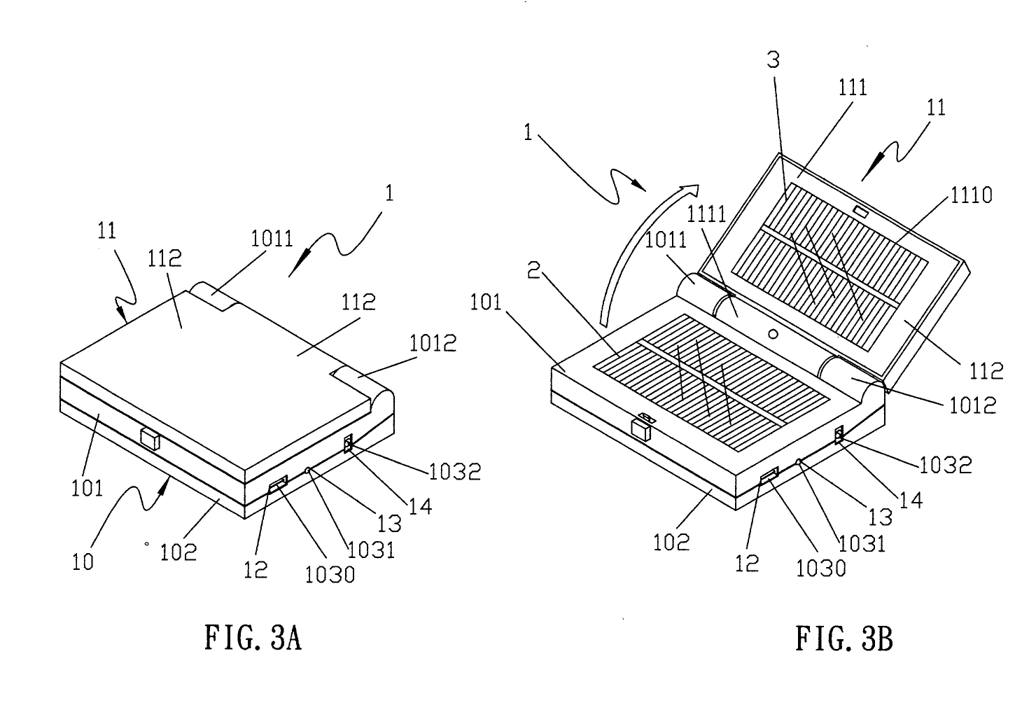

Now referring to FIG. 3A and FIG. 3B, two perspective view schematically illustrates two configurations of the embodiment of the invention. When the battery charge 1 is used, the cover part 11 and the case part 10 are unfolded. After use, the folding of the cover part 11 and the case part 10 on each other is facilitated by means of the spring 114.

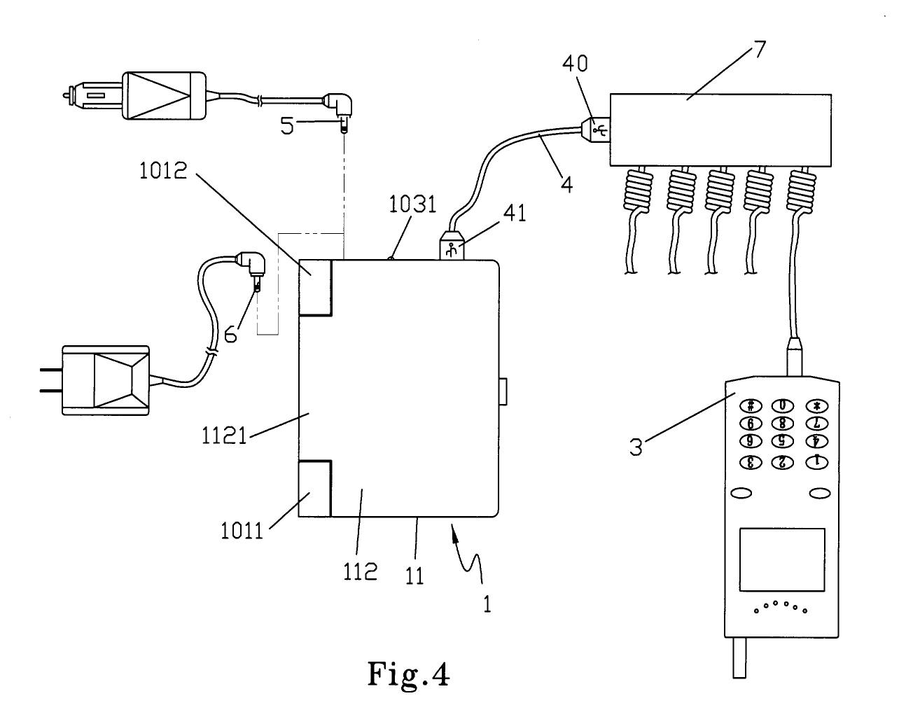

Referring to FIG. 4, a schematic view illustrates a utilization of the embodiment of the invention. When the user wants to use the battery charger 1, according to the adequate situation, he/she can choose a car charger plug or a portable charger plug to connect the battery charger 1 to the power source. The user can also unfold the battery charger 1 to externally expose the solar panels 2, 3 and convert sunlight to electricity. The circuit board 103 includes a voltage stabilizing circuit, a protection circuit, and particular circuits (such as a converter circuit that is capable of lowering the voltage delivered from the car cigarette igniter socket via the car charger plug or from the portable charger plug) (not shown). Via the voltage stabilizing circuit, the charging voltage of a mobile phone 3 connected to the battery charger 1 is stabilized.

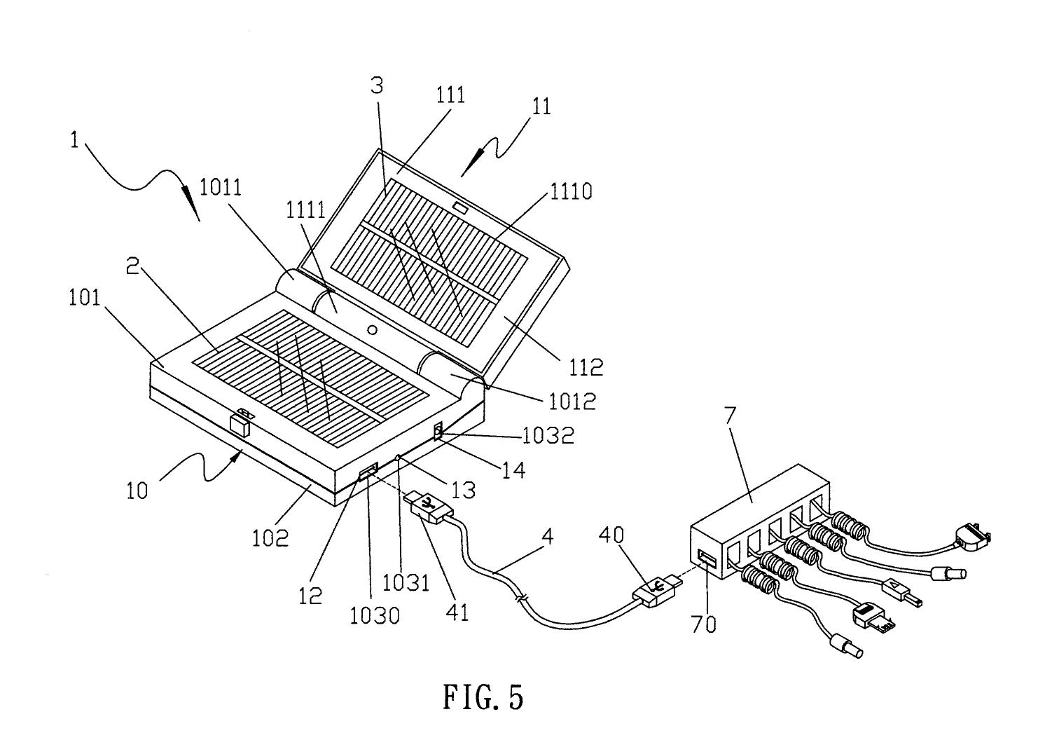

Referring to FIG. 5, a converter socket block 7 having a plurality of sockets adapted to different types of plugs of mobile phone may be provided. The converting socket block 7 electrically connects the battery charger 1 via the connecting cable 4 having a plug 40 connecting with the block 7 and an opposite plug 41 connecting with the socket 1030 of the battery charger 1.

Those skilled in the art will readily appreciate that the above description is only illustrative of specific embodiments and examples of the invention. The invention should therefore cover various modifications and variations made to the structure of the invention described herein, provided they are included within the scope of the invention as defined in the following appended claims.

What is claimed is:

1. A multi-socket solar energy converting battery charger for mobile phone, comprising:
a case part, including a first attachment panel, wherein the first attachment panel has a first opening and extends into left and a right attachment projections, the left attachment projection including a long cavity, the case part further including a tray that defines left and right receiving spaces;
a cover part, including a second attachment panel and a lower casing, the second attachment panel having a second opening, wherein an end of the second attachment panel forms a first partial cylinder including an abutment therein, an end of the lower casing forms a corresponding second partial cylinder, and a cylindrical rod is placed in the second partial cylinder and engages the long cavity to pivotally connect the case part and the cover part; and
first and second solar panels, respectively mounted to the first attachment panel and the second attachment panel and lower casing, and respectively exposed through the first and second openings.

2. The battery charger of claim 1, wherein the right receiving space of the case part receives a circuit board and sideways defines a socket area that includes a plurality of sockets.

3. The battery charger of claim 2, wherein the circuit board includes a protection circuit, at least a particular circuit, and a voltage stabilizing circuit, the circuit board being connected to one socket through which a connecting cable having two plugs connects the battery charger to a converter socket block that allows the connection of different types of mobile phone plug.
